(19) United States
(12) Patent Application Publication
(10) Pub. No.: US 2012/0180535 A1
(43) Pub. Date: Jul. 19, 2012

(54) LOCK PROTECTOR

(76) Inventor: George Carl DORSTE, Homestead, FL (US)

(21) Appl. No.: 13/353,743

(22) Filed: Jan. 19, 2012

Related U.S. Application Data
(60) Provisional application No. 61/434,090, filed on Jan. 19, 2011.

(51) Int. Cl. E05B 67/38

(52) U.S. Cl. 70/56

(57) ABSTRACT

A sleeve is sized to enclose a padlock, and has a central anchor which is positioned within an interior of the sleeve. A padlock is inserted into an interior of the sleeve, and the hasp is hooked to the central anchor. One chain or cable end is passed onto the padlock hasp, and the other end is either affixed to the anchor or also passed onto the padlock hasp, and the lock is closed to secure the cable to the padlock, and the padlock to the anchor within the interior of the sleeve. The sleeve is sufficiently durable to provide substantial protection from destruction of the padlock or the anchor.

### FIELD OF THE INVENTION

The present invention relates to a device and method for reducing the incidence of tampering with a locking device, and particularly a padlock.

### BACKGROUND OF THE INVENTION

Padlocks are portable locks used to secure cables, chains, or hasps, in order to protect property from theft or tampering, and/or to prevent access to a space. A padlock consists of a body housing, a locking mechanism, and a shackle. The body is designed to provide protection and support to the locking mechanism. The locking mechanism is a means for, usually, reversible securely retaining or releasing the shackle, and may include, for example, a combination or keyed mechanism. A shackle is, typically, a u-shaped bar that may pivot to admit the cable, chain, or hasp, and may thereafter be pushed into the body to be secured by the locking mechanism.

Padlocks are vulnerable to being broken by mechanical means, such as through the use of a hammer, bolt cutter, chisel, lever, drill, or grinder. The tool may be applied to any part of the lock, to destroy the physical integrity of the part, enabling release of the locked element. Other means of defeating a padlock is through exploiting a weakness in the locking mechanism, which may or may not accompany damaging the locking mechanism.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 depicts a perspective view of a lock protection device of the invention;

FIG. 2 depicts an end view of the device of FIG. 1;

FIG. 3 depicts an end view of the device of FIG. 1, with a padlock and cable installed;

FIG. 4 depicts an end view of an end opposite the depiction of FIG. 3;

FIG. 5 depicts a perspective view of the device of FIG. 3;

FIG. 6 depicts the device of FIG. 5, with a cable end connected to an internal post of the invention;

FIG. 7 depicts an alternative locking mechanism for use with the device of FIG. 6;

FIG. 8 depicts an alternative embodiment of a lock protector in accordance with the invention, in which the device forms a convex shape, and in which the sleeve has a closed end;

FIG. 9 depicts an alternative embodiment of a lock protector in accordance with the invention, in which the device forms a concave shape; and

FIG. 10 depicts an alternative embodiment of a lock protector in accordance with the invention, in which the device forms a rectangular shape.

### SUMMARY OF THE INVENTION

In accordance with the invention, an apparatus for protecting a lock having a hasp comprises: an elongated sleeve sized and dimensioned to completely enclose the lock, the sleeve forming an interior portion, an interior surface, and at least one open end having a peripheral surface; and an anchor securely attached to the interior surface of the sleeve, the anchor extending within the interior of the sleeve and operative to be hooked by the lock hasp, the anchor positioned away from the peripheral surface whereby when the anchor is hooked by a lock hasp, the lock hasp is not extendable past the peripheral surface of the at least one open end.

A peripheral surface of an open end is not notched thereby facilitating entry of a second hasp to be connected to a padlock hasp, the padlock hasp and connected second hasp to be hooked to the anchor.

In embodiments of the invention, the sleeve and anchor are metallic; the anchor is welded to the sleeve; the sleeve has a cylindrical or rectangular form; the anchor is attached to the sleeve within a central third of a length of the sleeve, thereby positioning a hooked hasp a substantial distance from a peripheral surface of an open end of the sleeve.

In yet another embodiment of the invention, an apparatus for protecting a lock having a lock body and a hasp comprises: an elongated sleeve sized and dimensioned to completely enclose the lock, the sleeve forming an interior portion, an interior surface, and two ends each defining a peripheral end surface; and an anchor securely attached to the interior surface of the sleeve, the anchor extending within the interior of the sleeve and operative to be hooked by the lock hasp, the anchor positioned within a central third of a length between the two sleeve ends, whereby when the anchor is hooked by a lock hasp, the lock hasp and lock body are not extendable past a peripheral end surface of the sleeve.

In a further embodiment, the anchor is positioned about centrally along a length of the cylinder extending between the cylinder ends.

### DETAILED DESCRIPTION OF THE INVENTION

In the description which follows, any reference to direction or orientation is intended primarily and solely for purposes of illustration and is not intended in any way as a limitation to the scope of the present invention. Also, the particular embodiments described herein are not to be considered as limiting of the present invention.

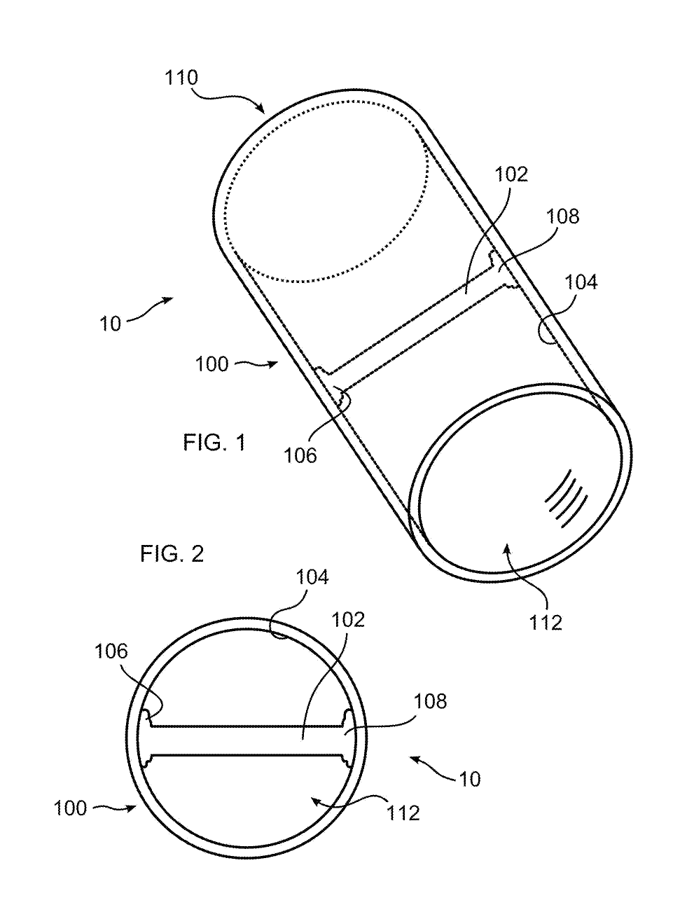

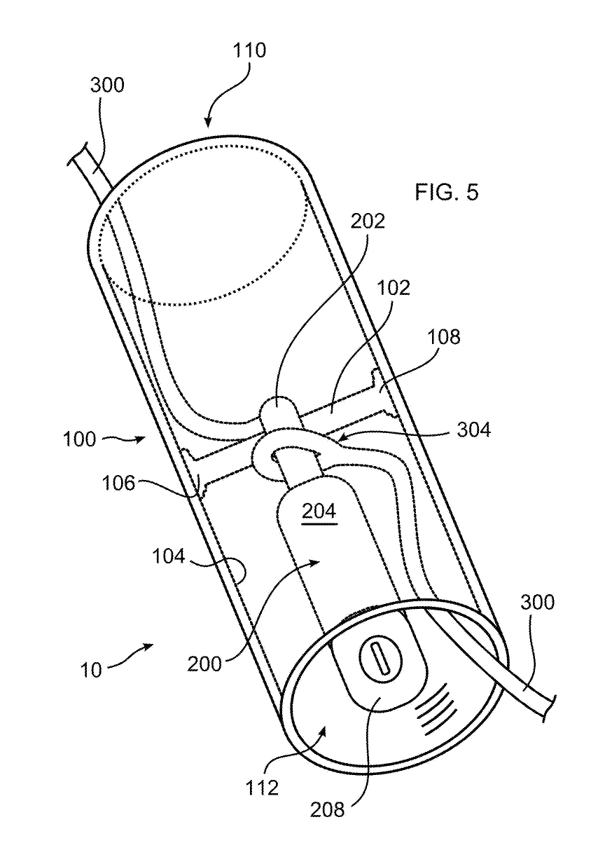

Referring now to the figures, in which like reference numerals refer to like elements, a lock protecting device 10 of the invention includes a sleeve 100 having an internally disposed anchor 102 securely connected to a surface 104 of sleeve 100. In the embodiment of FIGS. 1-8, anchor 102 is formed as an elongated member connected to an inner surface 104 at attachment locations 106, 108. In FIG. 1, attachment locations 106, 108 are welds, and anchor 102 is a bar which transects an interior of sleeve 100.

Attachment locations 106, 108 are advantageously at opposing inner surfaces 104 of sleeve 100, thereby providing additional strength to sleeve 100. Attachment locations 106, 108 may each advantageously be positioning an equivalent distance from an opening or end 110, 112 of sleeve 100. In this manner, access to anchor 102 and attachment locations 106, 108 is equally difficult for each attachment location 106, 108.

Alternatively, however, attachment locations 106, 108 may be on adjacent portions of surface 104; for example, anchor 102 may have a u-shape. In another embodiment, a single attachment location 106 or 108 may be provided. Anchor 102 may alternatively have the form of a loop, or a hook shape, or may extend incompletely from one attachment location 106 or 108 to an opposing surface 104, leaving a gap between anchor 100 and surface 104 at an end of anchor 100. In the latter embodiment, only a single attachment location 106 or 108 may provided, or anchor 100 may formed as a fully or partially closed loop. Where a gap exists between anchor 102 and a surface 104, or anchor 100 forms an incomplete loop having a gap, it is advantageous for a padlock 200 shackle or hasp 202 to be wider than the gap, so that a closed hasp 202 may not be removed.

Anchor 102 is advantageously positioned about centrally between sleeve ends 110, 112, whereby an correspondingly sized padlock 200 may be completely enclosed by sleeve 100, regardless of which end padlock 200 extends towards, once connected to anchor 102. In this manner, a destructive or defeating tool cannot be applied to any part of padlock 200 without extending the tool into an interior of sleeve 100. In one embodiment, anchor 102 is positioned about within the central third of the length of sleeve 100.

In FIGS. 1-9, sleeve 100 is formed as a cylinder, however as described further, below, sleeve 100 may be formed in any shape which creates a shroud or enclosure inhibiting access to an interior space.

Sleeve 100 may be fabricated from any material of sufficient strength and durability to provide a desired amount of resistance to damage to the physical structure or integrity of sleeve 100. Sleeve 100 is advantageously constructed of metal, for example, steel, stainless steel, aluminum, iron, or metal alloys. Materials which resist cutting, burning, impact, or bending are advantageous. Sleeve 100 is advantageously sufficiently durable to withstand attack by tools commonly used to defeat padlocks, which include pry bars, gas torches, saws, hammers, including sledge hammers, cutters, including long handled bolt cutters, chisels, and drills. Materials resistant to corrosion are advantageously used in outdoor or marine environments.

For applications in which physical or forceful tampering is of lesser concern than surreptitious methods of attack, sleeve 100 may be formed of less durable materials, while still inhibiting access to padlock 200, and rending a surreptitious attack more difficult, due to restricted access to padlock 200 by fingers or tools.

Anchor 102 may be fabricated with the same or different materials than sleeve 100. For attachment location 106 or 108 to be formed by welding, it is advantageous for anchor 102 to be fabricated with a similar material. Anchor 102 may be attached by any known means of sufficient strength and durability for a particular application, including for example adhesive, welding, brazing, pinching, extrusion, molding, or threaded connection.

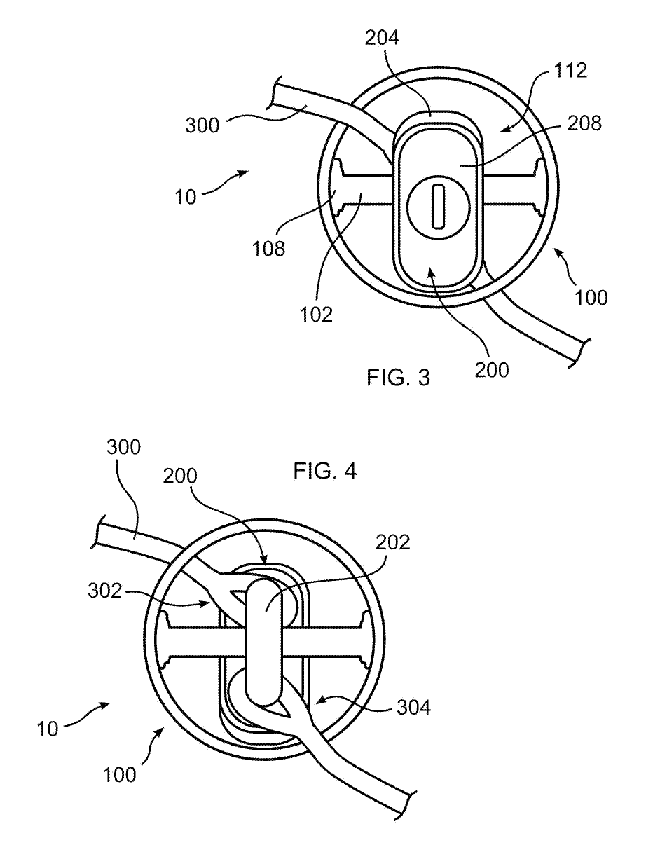

Use of a lock protecting device 10 of the invention may be understood with reference to FIGS. 3-4, in which a padlock 200 has been attached by a hasp 202 to anchor 102. A cable 300 has two looped ends 302, 304, both of which have been placed on hasp 202. When padlock 200 is locked, cable ends 302, 304 may not be removed from padlock 200, and padlock 200 may not be removed from anchor 102, absent destruction or defeat of padlock 200, hasp 202, anchor 102, or either cable end 302, 304. Cable 300 is looped around, through, or otherwise attached to an object to be protected from removal or access. For example, cable 300 could be looped through a removable item, for example a spare tire, or threaded through a frame member, for example that of a house or vehicle.

The assembled device 10, including sleeve 100, padlock 200, and cable 300 may be suspended from cable 300, placed upon a resting site, or an additional hasp or cable may be connected to hasp 202 in order to prevent movement of the assembled device 10. This may be advantageous to prevent positioning of assembled device 10 in a sturdy location whereupon a tool may be more easily applied to the assembled device 10, or whereby visual or manual access to padlock 200 might be facilitated.

While a flexible cable is illustrated in FIGS. 3-4, it should be understood that other structures may be connected with padlock 200 and hasp 202. Examples include a bar with a loop, a flat plate with an aperture, a chain, a braided or solid wire, or any other structure which may be passed through or onto hasp 202.

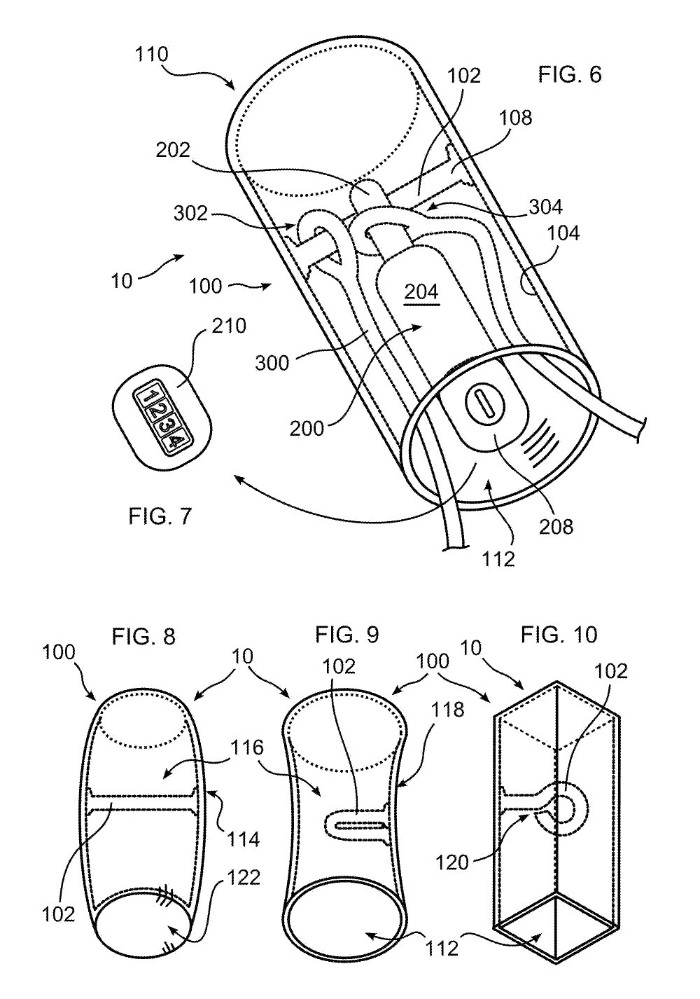

With reference to FIG. 6, it may be seen that one end of cable 300 may be affixed to anchor 102, for example prior to attachment of anchor 102 to sleeve 100. Alternatively, a cable end 302, 304 loop may be formed around anchor 102, then securely fastened, as by a crimp, weld, or other known means. In this manner, only a single cable end 302, 304 loop need be positioned through or upon hasp 202 in order to form an assembled device 10. It is further possible to pass cable 300 through or around an object to be secured, and to then pass one cable end 302 through the other cable end 304, and to then secure the passed cable end 302 to padlock 200.

FIG. 6 additionally illustrates, in an embodiment of the invention, anchor 102 is not centrally located within sleeve 100. In this manner, anchor 102 and hasp 202 remain sufficiently displaced from an end 110, and padlock body 204 is also maintained sufficiently within sleeve 100, to prevent or hinder access by a tool sufficiently destructive to defeat a security of device 10, particularly within a reasonable time for avoiding detection. A position of anchor 102 may therefore be determined in light of a size and configuration of padlock 200.

FIG. 7 illustrates an alternative release mechanism 210 for padlock, wherein mechanism 208 employs a key, and mechanism 210 employs a combination; however, any known release mechanism may be used in accordance with the invention, provided it may be accessed when padlock 200 is disposed within sleeve 100.

With reference to FIGS. 8-10, it may be seen that sleeve 100 may have a variety of configurations. In FIG. 8, sleeve 100 has a convex side surface 114 configuration, whereby additional space is created in the interior 116 of sleeve 100, thereby facilitating manipulation of padlock 200 within the space so formed. Concomitantly, ingress to the interior 116 remains restricted. FIG. 8 further illustrates that one end 110 or 112 may be closed, having a closed end 122. It should be understood that a closed end 110 or 112 may be provided in any of the embodiments illustrated or described, and that the instance of closed end 122 in FIG. 8, in particular, is merely exemplary.

Alternatively, in FIG. 9, sleeve 100 has a concave side surface 118 shape, whereby access to anchor 102 and or hasp 202 remains restricted, however insertion and movement of padlock 100 or cable 300 at sleeve end 110, 112 may be facilitated, in some applications. FIG. 9 further illustrates an alternative shape for anchor 102, in this instance a loop having attachment locations 106, 108 on adjacent areas upon surface 104. The association of the anchor shape of FIG. 9 and the sleeve 100 shape of FIG. 9 is merely exemplary; in accordance with the invention, any anchor 102 shape may be combined with any sleeve 100 shape.

FIG. 10 illustrates a sleeve 100 having a rectangular or rectilinear shape, which may expeditiously be formed from box section stock, or angle sections. Separate angle sections may be advantageously assembled and fastened together, for example by welding, after anchor 102 has been assembled onto one or more sections.

In the embodiment of FIG. 10, anchor 102 has the form of a loop or hook, with a gap 120 which may be closed or sealed according to strength and security needs of an intended application. As with FIG. 9, the particular anchor 102 shape is merely exemplary, and a sleeve 100 having a rectilinear form may be combined with any anchor 102 shape.

Exemplary dimensions for an embodiment of device 10 for commonly available padlocks include: sleeve 100 diameter, 4″; sleeve 100 length, 8″; anchor 102 thickness, ½″; and sleeve 100 wall thickness, 1/16^{th} inch. It should be understood, however, that the invention may be carried out within a very wide range of dimensions, for example a sleeve as small as an inch in diameter, or as large as several feet in diameter, without departing from the spirit and scope of the invention. These exemplary dimensions should not be construed to be limiting, in that sleeve 100 may be sized and dimensioned to protect a padlock of any size.

In operation, it is advantageous for there to be a relatively small gap between an extent of padlock dimensions and inner surface 104 of sleeve 100, with respect to a dimension of a destructive tool. In this manner, for example, jaws of a bolt cutter may not be inserted into sleeve 104, whereby they might possibly be used to cut hasp 202. Similarly, a saw blade may not be easily inserted into sleeve 100, or its movement readily controlled. For these reasons, it is advantageous for sleeve to be formed to completely surround hasp 202, or padlock body 204, from all sides, thereby uniformly frustrating an attempted breach of padlock 200, or anchor 102, from any angle. While anchor 102 need not be centrally located within sleeve 100, in accordance with the invention, anchor 102 advantageously remains sufficiently away from an end of sleeve 100 to avoid clear or unobstructed access to a cutting or breaking tool part.

While two ends 110, 112 are illustrated throughout the figures, where both are open to the interior, it should be understood that in any of the embodiments shown and discussed, one end 122, as shown in FIG. 8, may be closed, whereby cable ends 302, 304 and padlock 200 are all inserted from a single end. In this manner, an interior of sleeve 100 may offer protected from the elements, for example rain or snow, and an attack on padlock 200 or cable 300 may only be undertaken from a single end of sleeve 100. An end 122 may be closed, for example, by welding or affixing a part over end 110 or 112, by forming sleeve 100 with a single opening 110 or 112, or by welding or otherwise affixing sleeve 100 to a surface at one end 110, 112.

In accordance with the invention, anchor 102 is advantageously located a sufficient distance from a peripheral end surface of open end 110 or 112, whereby a destructive tool cannot directly access an attached hasp 202 of an attached padlock, without inserting the tool at least partway within an interior of sleeve 100. In this manner, for example, the stroke of a saw blade is hampered by contact with an inner side surface 104. This is similarly true for a hammer or chisel blow. Further, by positioning an attached hasp 202 substantially away from an end 110, 112 of sleeve 100, it may be difficult to position a drill tip end, or to visualize a striking or drilling location. Accordingly, sleeve 100 is advantageously not provided with cutouts or other significant deviation to a periphery of a surface of end 110 or 112, which may afford additional access to hasp 202 or padlock body 204. Such a deviation, such as a notch or other inwardly extending reduction in a periphery of end 110 or 112, would define a line extending from an innermost portion thereof, to an open end 110, 112 of sleeve 100. A tool could then be positioned along this line to gain improved access to hasp 202 or body 204. Accordingly, in one embodiment of the invention, anchor 102 would be positioned sufficiently within an interior of sleeve 100 such that no portion of a hasp 202 hooked upon anchor 102 would be extandable past a peripheral end of sleeve 100.

All references cited herein are expressly incorporated by reference in their entirety.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

1. An apparatus for protecting a lock having body and a hasp, the apparatus comprising:
an elongated sleeve sized and dimensioned to enclose the lock body, the sleeve forming an interior portion, an interior surface, and at least one open end having a peripheral surface; and
an anchor securely attached to the interior surface of the sleeve, the anchor extending within the interior of the sleeve and operative to be hooked by the lock hasp, the anchor positioned away from the peripheral surface whereby when the anchor is hooked by a lock hasp, the lock hasp is not extendable past the peripheral surface of the at least one open end.

2. The apparatus of claim 1, wherein said peripheral surface of an open end is not notched to facilitate entry of a handle or additional hasp.

3. The apparatus of claim 1, wherein the sleeve and anchor are metallic.

4. The apparatus of claim 1, wherein the anchor is welded to the sleeve.

5. The apparatus of claim 1 wherein the sleeve has a cylindrical or rectangular form.

6. The apparatus of claim 1 wherein the anchor is attached to the sleeve within a central third of a length of the sleeve, thereby positioning a hooked hasp a substantial distance from said peripheral surface.

7. An apparatus for protecting a lock having a lock body and a hasp, the apparatus comprising:
an elongated sleeve sized and dimensioned to completely enclose the lock hasp, the sleeve forming an interior portion, an interior surface, and two ends each defining a peripheral end surface; and
an anchor securely attached to the interior surface of the sleeve, the anchor extending within the interior of the sleeve and operative to be hooked by the lock hasp, the anchor positioned within a central third of a length between the two sleeve ends, whereby when the anchor is hooked by a lock hasp, the lock hasp and lock body are not extendable past a peripheral end surface of the sleeve.

8. The apparatus of claim 7, wherein the anchor is positioned about centrally along a length of the cylinder extending between the cylinder ends.

9. The apparatus of claim 1, further including a cable connectable to the hasp.

10. The apparatus of claim 1, further including a cable having a first end formed with a loop, said loop affixed to the anchor, and a second end connectable to the hasp.

11. The apparatus of claim 1, wherein the elongated sleeve is sized and dimensioned to completely enclose the lock body.

12. The apparatus of claim 1, wherein one end of said sleeve is closed.

13. The apparatus of claim 1, wherein said peripheral end defines along its length a substantially uniform distance from the anchor.

14. The apparatus of claim 1, wherein said anchor has the form of a hook, bar, or loop.

15. The apparatus of claim 1, wherein said anchor is fastened to opposing portions of said interior surface.

16. The apparatus of claim 1, wherein said sleeve forms a longitudinal axis, and defines a tapering profile along said longitudinal axis.

17. The apparatus of claim 1, wherein a peripheral surface of an open end is not notched to facilitate entry of a handle or additional hasp.

18. The apparatus of claim 1, wherein a peripheral surface of an open end is not notched to facilitate entry of a handle or additional hasp to be connected to the anchor.

19. The apparatus of claim 1, wherein said apparatus defines a longitudinal axis, wherein said open end is located at a first end of said longitudinal axis, and an open end or a closed end is located at a second end of said longitudinal axis, said peripheral surface substantially impeding access to the lock body or hasp from an axial approach with respect to the longitudinal axis along the entirety of the periphery, by a destructive tool capable of forcibly breaking the lock.

20. An apparatus for protecting a lock having a lock body and a hasp, the apparatus comprising:
an elongated sleeve defining a longitudinal axis having a first open end defining a peripheral edge, and a second, opposite end that is open or closed, the sleeve forming an interior and an interior surface;
an anchor securely attached to the interior surface of the sleeve, the anchor extending within the interior of the sleeve and operative to engage the lock hasp, the elongated sleeve sized and dimensioned to completely enclose the lock hasp, and to at least substantially enclose the lock body, when the lock is connected to said anchor, said peripheral surface substantially impeding access to the lock body or hasp from an axial approach with respect to the longitudinal axis along the entirety of the periphery.
